(19) United States
(12) Patent Application Publication
(10) Pub. No.: US 2007/0136778 A1
(43) Pub. Date: Jun. 14, 2007

(54) CONTROLLER AND CONTROL METHOD FOR MEDIA RETRIEVAL, ROUTING AND PLAYBACK

(76) Inventors: Ari Birger, Palo Alto, CA (US); Alexander Joffe, Palo Alto, CA (US); Ilya Netchitailo, Livermore, CA (US)

Correspondence Address: DOV ROSENFELD, 5507 COLLEGE AVE, SUITE 2, OAKLAND, CA, 94618, US

(21) Appl. No.: 11/608,190

(22) Filed: Dec. 7, 2006

Related U.S. Application Data
(60) Provisional application No. 60/748,837, filed on Dec. 9, 2005.

(51) Int. Cl. H04N 7/173; H04N 7/18

(52) U.S. Cl. 725/117; 725/81; 725/80; 725/100; 725/131; 725/120

(57) ABSTRACT

A remote control device for controlling a plurality of controllable devices, and a method for controlling devices using a remote control device. The remote control device includes a processor, a display screen coupled to the processor, and memory coupled to the processor, the memory including a program module to solicit information from a user. The program module has access to information regarding the operation of the plurality of controllable devices and which controllable device performs a selected function during operation of an activity. The program module generates a screen displayable on the display screen that includes different locations for playback, and a mechanism for the user to select one of the different locations for playback. As a result of a user providing the remote control device with an indication of the selected location for playback, and an item for playback at the selected location, the remote control device causes playback of the item at the selected location.

### RELATED APPLICATIONS

The present invention claims priority and is a conversion of U.S. Provisional Patent Application No. 60/748,837 filed Dec. 9, 2005 titled CONTROLLER AND CONTROL METHOD FOR MEDIA RETRIEVAL, ROUTING AND PLAYBACK, Attorney/Agent Ref. No. EYEC002-P. The contents of such U.S. Provisional Patent Application No. 60/748,837 are incorporated herein by reference.

### BACKGROUND

The present invention relates to playback of media content in a network, and to remote controls for such playback. More specifically, one embodiment of the invention includes an apparatus and another embodiment a method to facilitate a controlling of multiple appliances such as media playing devices in several locations, e.g., in a house. Embodiments include media retrieval, media routing and media playback in a network such as a home network.

Today's typical house has multiple sources of rich media content, including some or all of Internet data, Internet radio, satellite radio, Internet TV, voice over IP (VoIP) telephony, cable TV, satellite TV, stored digital TV, over-the-air broadcast TV, digital and analog home video, digital still images, e.g., from a video camera, and so forth. Such media content is also referred to as audiovisual content (“AV content”).

These sources are typically received at the home via several different devices, including, for example, one or more of: cable, satellite, and/or optical network set up boxes, TV receivers, computers, radio receivers, satellite radio receivers, and so forth.

The average house also has multiple media storage, retrieval and playback devices, also referred to as AV storage devices, AV retrieval devices, and AV playback devices. Some of these devices are stationary and some are mobile. Examples of such AV storage/retrieval/input/playback devices include: DVD players and recorders, CD players and recorders, analog phonograph record players, analog VCRs, digital video recorders (DVRs) such as TIVO™ devices, analog and digital camcorders, digital cameras, computers, MP3 players such as Apple IPod™ devices, and other storage/retrieval/input/playback devices.

Some of the storage devices such as DVD and CD players require manual handling to operate. For example, one needs to physically load and/or replace the content storage medium such as a DVD or a CD in order to play desired content stored in the medium.

Digital video recorders (DVRs) record content in digital format on large hard disk drives, and such drives are becoming larger day-by-day. Content from DVRs is thus accessible in the same form as a file on a computer. DVRs, however, are designed to be connected to a TV display, and DVR content is typically accessible only via a remote control and a display on the connected TV.

Media output devices, also called AV playback devices, are used as transducers to convert the information to a human perceivable form during playback. Such output devices might be classified as video output devices and audio output devices, although video output devices typically also include a mechanism for audio playback. Examples include video monitors, such as plasma, LCD, Analog TV monitors, and so forth, various surround sound systems receivers or amplifiers with speakers attached to them, and mobile devices.

Recently, home networks have started becoming more and more common. Devices that provide for streaming audio and/or audiovisual material via these networks have started to appear on the market. Such devices typically stream digital media content over the wired or wireless home network, typically from a computer or a computer-like device to a video and/or audio output device. These devices are treated as yet another component of a home entertainment center. Thus, the streaming devices are controlled just like any other component of the entertainment center, with its own remote control.

Examples of streaming devices include the PRISMIQ devices, made by PRISMIQ, Inc., Santa Barbara, Calif., and the Philips Philips Streamium™ devices for video, and the Philips Ensation™ device for wireless audio streaming (Philips, Eindhoven, Netherlands).

Dedicated audio servers also are now available on the market. See the Meda systems server, Meda Systems, Inc., Emeryville, Calif. Dedicated video servers also are becoming available for the home market.

More and more homes have multiple rooms in which the media content is played back, and in each such location, different devices may be involved for playing back the same media content.

Furthermore, there is a need in the art for a system that backs up media content stored in a plurality of storage devices.

Those in the art will understand that with this proliferation of media sources, storage, and playback devices, there is a need in the art for methods and systems to manage the content, including retrieving content, delivering and routing content to the desired location and output device, and backing up content.

As an example of the non-triviality of a seemingly simple task of displaying a digital image taken by a digital camera onto a flat panel, e.g., plasma display, one would now typically need to carry one's laptop computer into the living room, and connect it to the TV display, e.g., via a cable.

Some of the systems mentioned above provide for streaming media content over a home network. However, even then, navigating through a database of images and requesting a selected image to be displayed via one of these streaming devices is still very difficult.

Recently, computer systems that include a large amount of storage and that are designed for home entertainment use have been appearing on the market. Linux-based systems are known, as are Microsoft Windows™ based systems. Microsoft introduced an operating system and specifications for an operating system Microsoft calls the Microsoft Media Center Edition, which includes media content support and Microsoft Windows. Additionally, computers are now produced that include Microsoft Media Center Edition. Such computers are called Media Center PCs by Microsoft and herein. For example, RicaVision International, Inc., of Newport Beach, Calif. has introduced the PILX™ line of produces that includes a Media Center PC. A Media Center PC typically includes, in addition to standard personal computer components, additional removable hard drives, built in amplifiers with speaker outputs connections, multiple memory card readers accessible in the front, knobs for playback accessible in the front, a remote control, network connection and routing to one or more streaming devices for playback of video and/or audio, optional TV tuners, optional cable cards to connect to a cable TV system and provide the functionality of a set-top box (STB), and optional automatic backup, e.g., to a RAID drive system.

A typical house or even an office has multiple output devices such as monitors and TVs scattered at different locations, with associated audio, and also audio-only playback amplifiers and speakers at some other locations, as well as connected to a computer and a TV.

It is desired to be able to route content from any storage and/or input device to any output device. It is further desired to be able to select content from any chosen storage/playback device to be routed to a desired location.

The amount of content people own these days is becoming very large. Furthermore, such content now is provided in a multitude of formats. Furthermore, searching through this content is becoming progressively harder. Furthermore, as hardware prices continue to decrease, the most valuable possession is becoming the content, so that protecting content is very important.

Thus there is a need in the art to facilitate searching through content to select an item for playback.

Thus there further is a need in the art for methods and systems to back up content to protect it from destruction.

Thus there further is a need in the art for a method and apparatus that can handle the variety of formats that media content is provided in.

As wireless networks are becoming more pervasive, there further is a need to use wireless networking to route the selected input device or content/storage device via a wireless link to a selected output device.

Furthermore, with the multitude of various devices around the home, it has become extremely difficult to control these devices and to route the content from the requested source to the desired destination. Furthermore, with the explosion of content formats, is has become difficult to handle the variety of formats. Furthermore, keeping in mind that each of the devices that need to be controlled has its own unique user interface, it is becoming more and more difficult to remotely control the hardware. Note that a typical user interface/remote control provides for interaction of the hardware with humans at the level of hardware: turn on/off, change volume setting; select input source; etc. The reasons for this are mostly historical. Furthermore, remote controls for devices are typically unidirectional. A human issues commands. Often, there is a sequence of commands that are typically repeated. Thus, some remote controls provide for defining macros describing a sequence of commands. When a macro fails, corrective action becomes very difficult.

Remote control devices are known that attempt to guide a user through various potential problems, such a solution is only suitable for technically proficient, so-called “power users.”

Furthermore, although consumers these days have a large ever-increasing number of media content choices, e.g., a large number of TV program, movie, and music choices, typical equipment and control makes it increasingly difficult to manage these choices. Most consumer media devices require users either to enter numeric codes to make choices, or to “surf” sequentially through unwanted choices until they find what they want.

Digital Video Recorders such a TIVO™ now provide a more useful user interface in the form of a user's choices, favorites, favorite channels, and selected genres, titles, and actors. However, a TIVO player provides such a user interface for items to be recorded on the DVR, and not for selecting the items from a media center.

There is a need in the art to provide such a mechanism for selecting a media content item that is personalized to a particular user, and that is adaptable to be used on a portable device to select and route a choice to a selected output location. For example, to enjoy a particular TV program, a user now typically recalls or refers to a program schedule, and selects a channel number on a TV remote control. Similarly, to select a song from a multi-CD player holding hundreds of CDs, a user may now need to refer to a written list of what is contained in those hundreds of CDs and songs and enter the disk and track number on the multi-CD player's remote control. The alternative to such numeric control is to surf sequentially through items in a non-optimal order—such as the channel lineup order of a cable TV provider, or the sequence in which CDs and DVDs have been loaded into a multi-disc player.

Thus there is a need in the art for a controller that is able to provide an intuitive interface and mechanism:
for remotely intuitively selecting a “title” for playback using a personalized user interface.
for remotely routing the selected item from a selected media source to a selected media output device;
for intuitively selecting media source devices and a media output device; and
for selecting one or more items for playback from a (typically diverse) library of media content.

The Universal Plug and Play standard called UPnP is becoming more and more used for playback of media content in a network. See, for example, the UPnP Forum at www.upnp.org. UPnP describes an audiovisual architecture that includes interaction between UPnP control points and UPnP AV devices. The architecture is independent of any particular device type, content format, and transfer protocol, and supports a variety of devices such as TVs, VCRs, CD/DVD players/jukeboxes, set-top boxes, stereos systems, MP3 players, still-image cameras, camcorders, electronic picture frames (EPFs), network storage devices, and personal computers. The UPnP AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET/PUT/POST, RTP, TCP/IP sockets, UDP, etc.).

In UPnP scenarios in general, each control point controls the operation of one or more UPnP devices in order to accomplish the desired behavior. The individual devices do not interact directly with one another. All of the coordination between the devices is performed by one or more control points and not the devices themselves. For flow of content from one device to another, an AV control point interacts with two or more UPnP devices acting as content source, called a media server and a content sink, called a media player, respectively. Although the control point coordinates and synchronizes the behavior of both devices, the devices themselves interact with each other using a non-UPnP communication protocol called an “out-of-band” communication protocol in the context of UPnP. The control point uses UPnP to initialize and configure both devices so that the desired content is transferred from one device to the other. However, since the content is transferred using an “out-of-band” transfer protocol, the control point is not directly involved in the actual transfer of the content. After the transfer has begun, the control point can typically be disconnected without disrupting the flow of content.

According to conventional UPnP AV architecture, three distinct entities are involved: 1) the control point, 2) the source of the media content, called the “media server”, and the sink for the content, called the “media renderer” or simply “media player” or “media playback device” herein. While in this disclosure, all three entities are often described as if they were independent devices on the network, and such a configuration is actually possible, e.g., a VCR (the media server), a control device, e.g., coupled to a remote control (the control point), and a TV (the media player), those in the art will understand that the UPnP AV architecture supports arbitrary combinations of these entities within a single physical device. For example, a TV can be treated as a media player device e.g., a display. However, since most TVs contain a built-in tuner, the TV can also act as a media server device because it could tune to a particular channel and send that content to a Media Renderer, e.g., its local display or some remote device such as a tuner-less display monitor. Similarly, many media servers and/or media players may also include control point functionality. For example, an MP3 renderer will likely have some UI controls (e.g. a small display and some buttons) that allow the user to control the playback of music.

For more details on UPnP, see for example, “UPnP AV Architecture:0.83, For UPnP™ Version 1.0” from the UPnP Forum, www.upnp.org, dated Jun. 12, 2002.

Devices may have their own control points. For example, it is common for playback devices to have a dedicated control point, e.g., a control point sold with, even incorporated with the playback device, and dedicated to controlling the playback device. Thus, a UPnP-compliant STB for video playback may have a dedicated control point that includes an infra-red (IR)-linked remote control. A CD playback device may also have a dedicated control point that may be linked, e.g., via IR to a CD remote control device. Furthermore, new devices called “digital media adapters” are available that act as UPnP control points, and that are linked to a common remote control. Lynksys of Irvine, Calif. (a Division of Cisco Systems, Inc.) sells a wireless Digital Media Adapter (Linksys model WMA11B) that includes a wireless access point, a wired network interface, and a processor that executes software implementing a UPnP control point. The wireless digital media adapter device is coupled to a remote control that provides a user interface for the control point.

Note that according to convention, control points are the only components that initiate UPnP actions.

Those in the art will understand that in a network environment that includes a plurality of control points, one or more media servers, and a plurality of media players, in order for each control point to properly function, e.g., be able to control playback of media content on each playback device, each control point needs to discover all the devices on the network, and obtain their capabilities. Furthermore, each control point needs to have the correct state of each device in the network. A problem can occur that the state known to the different control devices is not the same, so that errors can occur. Furthermore, in some networks, it takes some time for the different control points to become fully synchronized. Furthermore, in order for a control point to maintain information on each device, the control point possibly needs to be able to operate a complex set of user interfaces for the various devices, and maintain information on, for example, the content in each media server. Therefore, a typical control point would need to have processing power and memory or other storage sufficient to carry out these functions efficiently.

There is therefore a need in the art for the efficient operation of several devices in an architecture that conforms to UPnP.

### SUMMARY

Described herein is a remote control device that provides an intuitive interface for controlling a home entertainment network that includes one or more media source devices, one or more media storage/playback devices, one of which is a media server maintaining media content items in electronic form, and one or more media output devices. Also described herein is a method of controlling a home entertainment network by a remote control device including presenting a user interface to a user. By controlling is meant one or more of routing the media path from input or playback/storage device to output device, and selecting one or more items for playback.

One particular embodiment includes an apparatus comprising: a processor; a display screen coupled to the processor; an input device operable to accept user input from a user; and memory coupled to the processor. The memory includes logic operable when executed by the processor to solicit information from a user, the logic having access to information regarding operation of a plurality of controllable devices that are remote from the apparatus, information regarding content for playback, and information regarding controls available for each respective controllable devices; and the playback capabilities of each controllable device. The logic is further operable when executed by the processor to generate a visual display of a user interface on the display screen that includes set of locations where there are one or more playback devices, such that a user can select one of the different locations for playback using the input device, and further select one or more items of content for playback, such that as a result of accepting user input a content item for playback at the selected location, and an indication to playback the selected content item, the remote control device causes playback of the content item at the selected location.

One particular embodiment includes a method comprising causing a screen of a remote control device to display a user interface that includes a set of locations where there are one or more playback devices and one or more controls operable by a user of the remote control device to select one or more of the locations for playback. The method further comprises receiving from the remote control device a user selection of one or more locations for playback. The method further comprises causing the remote control device to provide for the user a mechanism to select from a set of content items for playback at the selected one or more locations, and receiving from the remote control device a user selection of one or more of the set of content items and an instruction to playback the selected one or more content items, such that as a result of the user's selecting to playback the one or more content items using the remote control device, playback of the selected one or more content items occurs at the selected more locations.

One particular embodiment includes logic embodied on one or more tangible computer readable media, the logic for execution in one or more processing systems that are coupled to a network, the logic comprising control point logic that when executed in one of the processing systems is operable to communicate with one or more media players and/or with one or more media servers, each media player and media server coupled to the network and conforming to a standard that uses a standard communication control protocol, the control point logic when executed further operable to control any one of media players and any one of the media servers using the standard communication control protocol, the control protocol able to cause playback at a selected media player of a selected item of content of a selected media server, the playback including transfer of the data of the selected item of content from the selected media server to the selected media player. The logic further comprises control server logic that when executed in one of the processing systems is able to communicate with the control point logic, and is operable to access a control database including information for controlling one or more of the media players and media servers, the control server logic further operable to receive data from one or more remote control devices, the control server module operable to interpret data received from a selected remote control device and to cause the control point module to control any one of media players and/or any one of the media servers according to the received data.

In one embodiment, the control server logic is further operable when executed to send data to the selected remote control device and further able to interpret data from the control point module and send corresponding data to the selected remote control device.

In one embodiment, the standard is the Universal Plug and Play standard also denoted UPnP.

In one embodiment, the control server logic when executed is operable to cause a screen of a remote control device to display a user interface that includes a set of locations where there are playback devices and one or more controls operable by a user of the remote control device to select one or more of the locations for playback. The control server logic when executed is further operable to receive from the remote control device a user selection of one or more locations for playback; to cause the remote control device to provide for the user a mechanism to select from a set of content items for playback at the selected one or more locations; and to receive from the remote control device a user selection of one or more of the set of content items and an instruction to playback the selected one or more content items. The logic is arranged in a manner such that as a result of user's selecting to playback the one or more content items using the remote control device, playback of the selected one or more content items occurs at the selected one or more locations.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### BRIEF DESCRIPTION OF THE DRAWINGS

FIG. 1A shows an example network in a home containing storage/retrieval/input/playback devices and coupled to the Internet. Some embodiments of the present invention operate in a home network exemplified by FIG. 1A.

FIG. 1B shows another example network of networks in a home containing several AV devices—storage/retrieval/input/playback devices—that are connected by the network of networks and that includes an embodiment of the present invention. Shown in parentheses are the roles some of these devices have in an AV architecture that conforms to a Universal Plug and Play (UPnP) AV architecture. Some embodiments of the present invention operate in a home network exemplified by FIG. 1B.

FIG. 2 shows a simplified block diagram of an example mobile remote control device such as a personal digital assistant (PDA) in which some embodiments of the present invention can operate.

FIG. 3A shows a simplified block diagram of another example device that can operate as a remote control according to some embodiments of the present invention.

FIG. 3B shows a simplified block diagram of a server device, e.g., a PC that includes logic that when executed in the server device implements a control server embodiment coupled to a control point embodiment according to one or more versions of the present invention.

FIG. 4 shows a simplified representation of a remote control device displaying a location user interface that is presentable to a user to select a location for playback, according to an embodiment of the invention.

FIG. 5A shows a simplified representation of a remote control device displaying a browse location user interface that is presentable to a user once the user has made a selection, according to an embodiment of the invention.

FIG. 5B shows a simplified representation of a search screen display that is presentable to a user when the user invokes the search function according to one embodiment of the invention.

FIG. 6A shows a simplified representation of a screen that, in one embodiment, provides for alphanumeric input, e.g., of search terms. Such an alphanumeric screen is used to implement a feature of some embodiments of the present invention.

FIG. 6B shows a simplified representation of one alternate form of alphanumeric entry in which an image of all alphanumeric characters is presented together with some control buttons, according to one embodiment of the invention.

FIG. 7 shows a simplified representation of a location playback control screen when an item is being played, e.g., after a user invokes an item's playback at a selected location, according to one embodiment of the invention.

FIG. 8 shows a simplified representation of a screen with the common control part and an example channel selection display that includes channel selection controls, according to one embodiment of the invention.

FIG. 9 shows a simple representation of a conventional UPnP AV architecture.

FIG. 10 shows a simple representation of a UPnP AV architecture according to an embodiment of the present invention.

Other features and properties and details will be clear from the description provided herein.

### DETAILED DESCRIPTION

Described herein is a remote control device that provides an intuitive interface for controlling a home entertainment network that includes one or more media source devices, one or more media storage/playback devices, one of which is a media server maintaining media content items in electronic form, and one or more media output devices. By controlling is meant one or more of routing the media path from an input or playback/storage device to an output device, and selecting one or more items for playback.

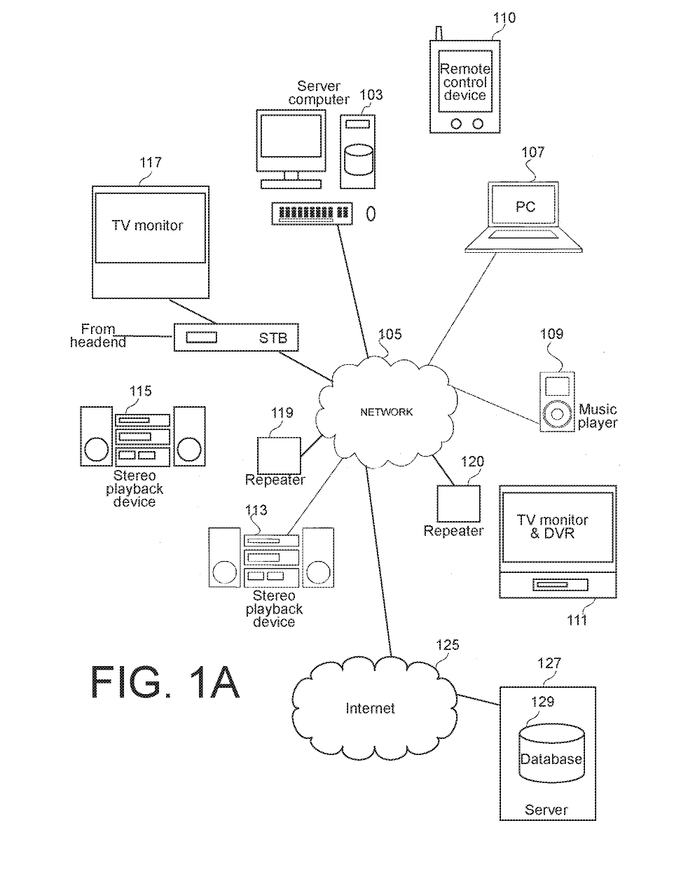

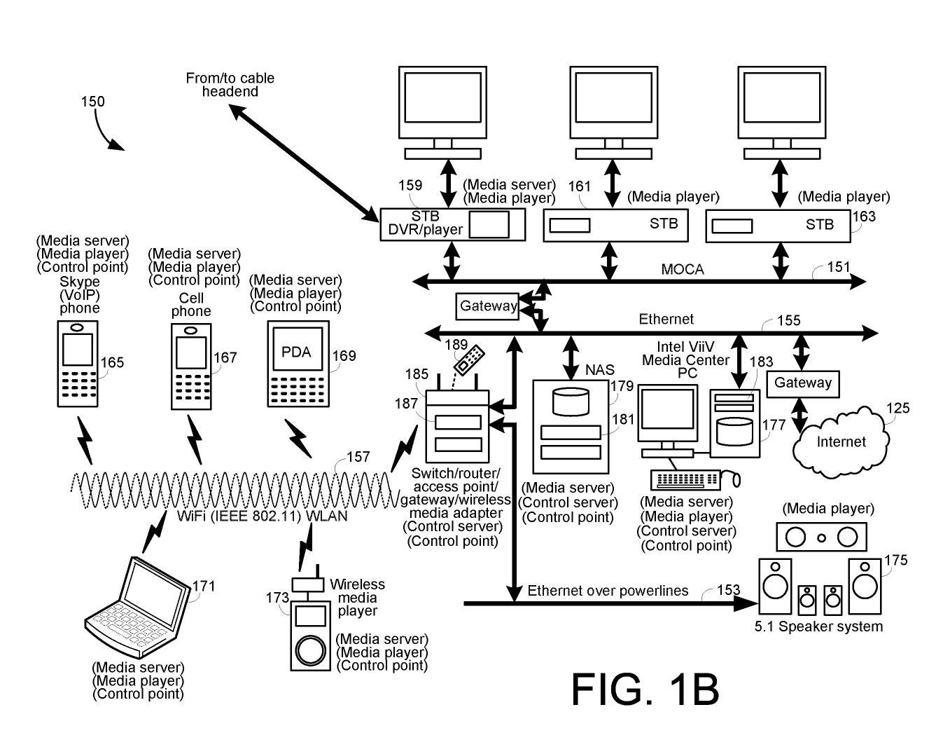

FIG. 1A shows an example home entertainment network in which an embodiment of the present invention can operate. The devices shown include a server computer 103 in which media content items are stored, e.g., a Media Center PC operating Microsoft Media Center Edition. The server computer 103 thus acts as a storage device and is coupled to a network such as a wireless local area network operating under one of the IEEE 802.11 standards. In alternate embodiments, other wired or wireless networks may be used, e.g., networks that operate via household power lines, or standard network wiring.

Coupled to the network are various storage/retrieval/input/playback devices that are typically located in different rooms of the house. Some of the devices are network capable storage/retrieval/input/playback devices directly coupled to the network, while other storage/retrieval/input/playback devices may be legacy devices operated by standard remote controls, e.g., remote controls that use infrared (IR). Coupled to the network are shown repeaters 119, 120 that each is capable of translating network data into IR remote control signals to operate one or more legacy devices that are in the same room as the respective repeater 119 or 120. For example, a stereo playback system 115 that includes radio, CD, and other playback is shown close to repeater 119, while a TV monitor 111 with a DVR is shown close to repeater 120.

Also shown coupled to the network are a video playback device 117, a laptop PC 107, an MP3 playback device such as an Apple IPod™ 109, and another network-connected audio playback system 113. Such storage/retrieval/input/playback devices (monitors, TVs, audio-only playback devices, audio speakers, etc.) are located at various locations in the house.

While the embodiment shown includes an IR transmitter and receiver in the remote control device, in alternate embodiments, the server computer 103 includes the IR transceiver (transmitter and receiver). One embodiment uses a Media Center PC for (or in addition to) computer server 103 and also uses Microsoft Media Center Extenders. The network includes a USB IR transceiver added to each Media Center Extender and to the Media Center PC. The remote control device 110 communicates commands to the Media Center PC via the network 105, and then these are transmitted via the network to the appropriate Media Center Extender. The IR transceiver coupled to the Media Center Extender then sends the appropriate commands to the playback/input/storage device for that Media Center Extender.

In one embodiment, the network 105 is coupled to another network, e.g., the Internet 125. Coupled to the Internet 125 may be one or more servers 127 containing one or more databases of media content 129. While FIG. 1A shows a direct connection between the Internet 125 and network 105, those in the art will understand that such a network connection may typically be achieved via a computer, e.g., server computer 103.

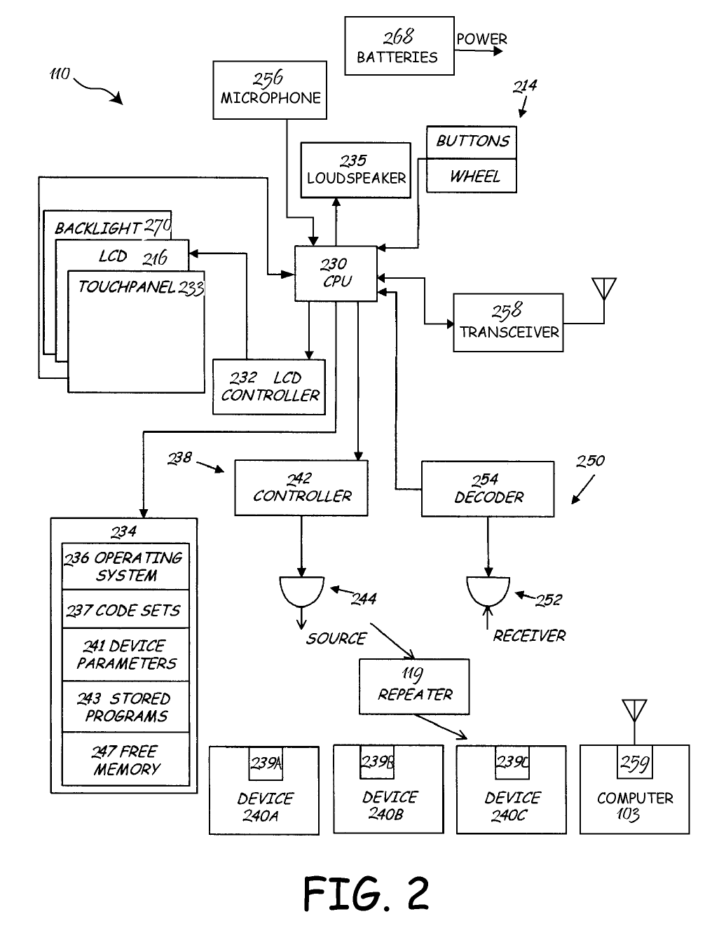

One embodiment of the remote control device 110 includes the ability to playback one or more forms of content, e.g., audio, video, or the like on its speaker 235 and/or display 216 (FIG. 2). Thus, some embodiments of the invention include the feature that the remote control device 110 is a media playback device.

Note that in one implementation, each of one or more of the storage/retrieval/input/playback devices connects to the server computer 103, which in one embodiment is a Media Center PC running Microsoft Media Center Edition, via what Microsoft calls Microsoft Windows Media Center Extender™. With present day implementation of Microsoft Media Center Edition, up to five different instances of Media Center Extender devices can run at the same time. Such instances of Microsoft Windows Media Center Extender™ operate to route media content stored in the server computer 103 to one or more storage/retrieval/input/playback devices. Using such an arrangement, as an example in a house that has a few rooms, including a living room and a den, a first user can be watching a movie stored in the server computer 103 using a Windows Media Center Extender in the living room of the house, while another user may be browsing through the family's music collection on the server computer 103 from the den of the house.

Using a remote control device, it is desired to be able to route content from any storage/retrieval device to any output device. It is further desired to be able to select content from any chosen storage/retrieval/input device to be routed to a desired location. It is also desired to be able to see what playback systems are in operation in any location, and also who is playing in such location, and also what is playing in such location. It is also desired to be able to control such playback. It is also desired to have a hierarchical privilege system, e.g., a parental control system, so that normally, a user has privacy in selecting what is being played, so that another user may not be able to remotely access such information, and also so that another user may not be able to remotely control such playback, but with some users having greater privilege than others, so that, for example, parents can control playback by children (but not vice-versa), including controlling what content is playable.

One embodiment of the invention includes the feature that remote control of the devices, e.g., of routing and of content selection is carried out on a remote control device 110 that can be a personal digital assistant (PDA) such as: a PocketPC™ or a Palm Pilot™, a mobile telephone such as a cell phone or a Voice over IP (VoIP) phone, a laptop computer, a special purpose remote control device, or any device that includes a processor, memory, a display screen, and an input mechanism for a user to input commands, e.g., a touch sensitive screen or a mechanism for moving a pointer such as a cursor icon and making a selection (“clicking”) on the place pointed-to by the cursor.

FIG. 1B shows an example of a more complicated network 150 of devices. The network that connects the devices is a network of networks and includes a Media over Coax (MOCA) network 151, an Ethernet over powerlines network 153, a wired local area network, e.g., an Ethernet 155, and a wireless network (wireless local area network, WLAN) 157, e.g., a Wi-Fi network that conforms to the IEEE 802.11 standard. The network 150 also includes a connection to another network, e.g., the Internet 125. Coupled to the Internet 125 may be one or more servers 127 containing one or more databases of media content 129 as in FIG. 1A.

In one embodiment, the AV devices in FIG. 1B conform to the UPnP standard, and are used to illustrate embodiments of the invention that operate with devices that conform to the UPnP standard. The role or roles of each AV device in FIG. 1B is shown in parentheses.

FIG. 1B includes an STB and DVR combination 159 that is coupled via cable to a cable headend, and also coupled to the MOCA network 151. The STB/DVR player is capable of playback and is also the source of AV content, so it is a media server in the UPnP context. Also coupled to the MOCA network are a first STB 161 and a second STB 163. Each of these is a media player in the UPnP context and is coupled to an AV monitor for viewing AV content. The MOCA network is coupled to the Ethernet 155.

Coupled to that Ethernet 155 is a network attached storage device (NAS) 179 wherein media content is stored. The NAS device 179 is used as a media server in the UPnP context, so it can be set up by a control point to send content for playback to a playback device in the out-of-band channel. In one embodiment, the NAS device 179 includes logic 181, e.g., software, e.g., in memory that when executed implements an embodiment of what we call a “control server” as described in more detail below, and is also used to implement a control point connected to the control server. The control server in one embodiment communicates with one or more remote control devices that provide a user interface for controlling via the control point. The control point and control server implement one or more features of the invention. See below for more details.

Also coupled to the Ethernet 155 is a personal computer (PC) 177 that is set up in the UPnP context to be a media server, a media store configurable to send AV media (“AV content”) to another media server, a media player to playback AV content, and a control point. In one embodiment, the PC is an Intel ViiV PC (Intel Corporation, Santa Clara, Calif.) that uses the Microsoft Media Center Edition as its operating system. In an alternate embodiment to the one in which the NAS device 179 includes logic operable to implement a control server and control point, the PC includes logic 183, e.g., software, e.g., in memory and storage that when executed on a processor of the PC 177, implements an embodiment of a control server and a control point connected to the control server as described in more detail below.

The Ethernet 155 is also coupled to the Internet 125, and also to the Ethernet over powerlines network 153. In FIG. 1B, there is a 5.1 speaker system 175 coupled to that Ethernet over powerlines network 153 that acts as a media player in the UPnP context.

Also coupled to the Ethernet is a wireless network access point 185 for the wireless network 157. In one embodiment, the wireless network access point also acts as a switch or router, and also a gateway for other networks. In one embodiment, the wireless network access point 185 is also operable as a so called “wireless media adapter” that acts as a control point in the UPnP context. A remote control device 189 can communicate with the wireless media adapter 185 to control one or more of the devices and to locate content in one or another media server. In one embodiment, the wireless media adapter 185 includes a processor and a memory. In an alternate embodiment to the one in which the NAS device 179 or the PC 177 includes logic operable to implement a control server and control point, the wireless media adapter 185 includes logic 187, e.g., software, e.g., in the memory that when executed on the processor of the wireless media adapter 185, implements an embodiment of a control server and a control point connected to the control server as described in more detail below.

Several devices are shown coupled to the wireless network 157. A laptop PC 171 and a wireless portable media player 173, e.g., a wireless MP3 and video player 173, are operable to be coupled to the WLAN. Each of these can have the roles of a media server, a media player, and/or a control point in the UPnP context.

Also connectable to the wireless network 157 are some portable devices that each can be used as a remote control that includes one or more features of the present invention. For example, in an embodiment in which the NAS device 179 also acts as what we call a control server as well as a control point coupled to the control server, or in an embodiment in which the PC 177 also acts as what we call a control server as well as a control point coupled to the control server, each of these portable devices may be operable to communicate with the control server to provide remote control functionality to one or more of the media player devices and/or locate content and set up playback thereof.

In alternate embodiment, each such portable device is a remote control that includes one or more features of the present invention.

The portable device is primarily a voice-over-IP (VoIP) phone 165, such as a Skype phone (Skype, an eBay company, Luxembourg), and includes a processing system and software to implement remote control functions including one or more features of the present invention. In one embodiment, the VoIP phone 165 also includes components operable to store and playback media (content), so in the context of UpnP, can have the role of a control point, a media server and a media player. As described further below, in some embodiments, some remote control features are in conjunction with services remote to the device, e.g., software running on the media center PC 177 implementing what is called a control server that is coupled to a control point also implemented on the media center PC 177.

Another device in the example network 150 connectable to the wireless network is a mobile cellular phone that includes a wireless network interface to connect to the wireless network 157, and that includes a processing system and software to implement remote control functions including one or more features of the present invention. In one embodiment, the cell phone 167 also includes components that are operable to store and playback content (media), so in the context of UpnP, the cell phone 167 can have the role of a control point, a media server and a media player. As described further below, in some embodiments, some remote control features are in conjunction with services remote to the device, e.g., software running on the media center PC 177 implementing what is called a control server that is coupled to a control point also implemented on the media center PC 177. Similarly, included in the network 150 is a personal digital assistant (PDA), e.g., hand-held computer 169, e.g., one operating under Microsoft Pocket PC. The handheld computer 169 includes a wireless network interface to connect to the wireless network 157, and that includes a processing system and software to implement remote control functions including one or more features of the present invention. In one embodiment, the handheld computer 169 also includes components that are operable to store and playback media content, so in the context of UpnP, the handheld computer 169 can have the role of a control point, a media server and a media player. As described further below, in some embodiments, some remote control features are in conjunction with services remote to the device, e.g., software running on the media center PC 177 implementing what is called a control server that is coupled to a control point also implemented on the media center PC 177.

FIG. 2 illustrates functional components of an example remote control device 110, which in this drawing is a PDA. The PDA includes a processing system that includes a processor, e.g., a central processing unit (CPU) 230 that executes software to implement the software controlled functions of the remote control 110 of FIG. 1A or one of devices 165,167, 169 in FIG. 1B. In the following discussions, when describing the remote control device 110, the reader should understand that this can be any remote control device, e.g., the device shown in FIG. 1A, or one of devices 165,167, 169 of FIG. 1B.

While several elements are shown and/or described as coupled to the CPU 230, those in the art will understand that this coupling s typically via a bus structure not shown herein. The CPU 230 is coupled to a LCD controller 232 that in turn is coupled to a display 216. A keypad is included 214. The CPU 230 provides signals to the LCD controller 232 so that text and graphic icons can be generated on the display 216 in accordance with controlling software being executed. A touch sensitive panel 233 provides signals to the CPU 230 as a function of activation, including location of the activated point. A loudspeaker 235 provides audio output, e.g., as feedback.

Memory 234 is also coupled to the CPU 230. In the embodiment illustrated, the memory 234 stores operating system software 236 that controls the basic functionality of the PDA, including software to operate the remote control 110, e.g., interaction of the user with the keypad 214 and the display 216, and other operating system kernel functions, e.g., the loading and execution program modules, such as a setup program module. In one embodiment, the memory 234 also stores a database called the “control database” that includes a database of code sets 237 associated with various types and brands of media devices, e.g., storage/retrieval/input/playback devices that can be operated with the remote control, and device parameters 241 such as the time. The memory 234 also stores the stored programs 243 and free memory 247 used for temporary data storage during program execution. The memory 234 can be implemented as a combination of read/write memory, such as static random access memory (SRAM), and read-only memory, such as electrically programmable read only memory (EPROM).

In another embodiment, the “control database” that includes the database of code sets 237 associated with various types and brands of media devices that can be operated with the remote control, and the device parameters 241 is stored remotely in another processing system to which the device 110 is connectable, e.g., via a network. In one such embodiment, the remote control device 110 can be a “lightweight” device that is relatively inexpensive to manufacture, and whose processor 230 can be relatively simple.

In one embodiment, the remote control device 110 includes a wireless network transceiver 258 interfaced and coupled to the CPU 230. This provides for a wireless network connection, e.g., to the network 105 (FIG. 1A), including, for example, to the computer server 103 via the network 105 and a wireless network interface 259 of the computer server 103.

In one embodiment, the remote control device includes infrared (IR) receiver 250 and infrared transmitter 238, and in another, a wireless transmitter and receiver using other than IR. The transmitter 238, coupled to the CPU 230, transmits signals from the remote control unit 110 to a receiver 239A of a first controllable storage/retrieval/input/playback device 240A. Other controllable storage/retrieval/input/playback devices that can be controlled by the remote control unit 110 are illustrated as storage/retrieval/input/playback devices 240B and 240C, and in general, there will be many such storage/retrieval/input/playback devices. Each of the controllable storage/retrieval/input/playback devices 240B and 240C also include a receiver 239B and 239C, respectively. In the embodiment illustrated, the transmitter 238 is a transmitter having a controller 242 and an infrared transmitting light source 244. The controller 242 controls operation of the light source 244 in a manner well known to those skilled in the art to encode commands for the controllable storage/retrieval/input/playback devices 240A-240C. Each receiver 239A-C of the controllable storage/retrieval/input/playback devices 240A-240C receives the transmitted infrared signals; however, only the intended controllable storage/retrieval/input/playback device 240A-240C responds to the encoded transmitted signal to perform the required action. Although illustrated with an infrared transmitter, it should be understood that some embodiments of the present invention can be implemented with other types of transmitters such as radio transmitters that transmit analog and/or digital signals. Furthermore, a repeater 119 can be used anywhere in the transmission path from the remote control unit 110 to the controllable storage/retrieval/input/playback device's receiver 239A,239B, and/or 239C to transmit command signals. The repeater 119 is commonly used in applications where walls, doors or other objects prevent direct transmission of the command signals to the controllable storage/retrieval/input/playback device's receiver 239A, 239B, and/or 239C.

It should also be understood that the controllable storage/retrieval/input/playback devices 240A-240C can be any number of various brands, models or types of storage/retrieval/input/playback devices, e.g., media playback devices that can be controlled by the remote control unit 110. Some examples include televisions, video cassette recorders, cable converters, compact disk players, audio tuners, audio cassette players, satellite tuners, laser disc players, lights, security devices, appliances, etc.

In a further embodiment, the remote control unit 110 can receive information in addition to transmitting command signals. In one embodiment, the remote control unit 110 can learn encoded IR command signals transmitted from other storage/retrieval/input/playback device specific remote control units. A receiver 250 receives the command signals to be learned. In the embodiment illustrated, the receiver 250 includes an infrared sensing element 252 coupled to a decoder 254. The infrared sensing element 252 receives the transmitted IR command signals, providing a corresponding output signal to the decoder 254. The decoder 254 decodes the output signal for use by the CPU 230.

In one embodiment, an additional device with which the remote control unit 110 can communicate is a remote computer such as computer server 103. The computer server 103 and the remote control unit 110 can communicate data, such as additional code sets from the control database in the computer server 103 and stored in the memory 234 of the remote control unit 110. If desired, advanced programming for the remote control unit 110 can be performed on the computer server 103, and then subsequently downloaded e.g., via the network 105. In addition, settings, programming and/or IR codes of the remote control unit 110 can be stored on the computer server 103 in the event the remote control unit 110 is lost or stolen.

Power is provided by batteries 268 to each of the above-described components of the remote control unit 110 and a backlight 270 that illuminates the display. In another embodiment, power can be provided from household AC current. Preferably, at least a portion of the memory 234 will retain data in the event of power loss.

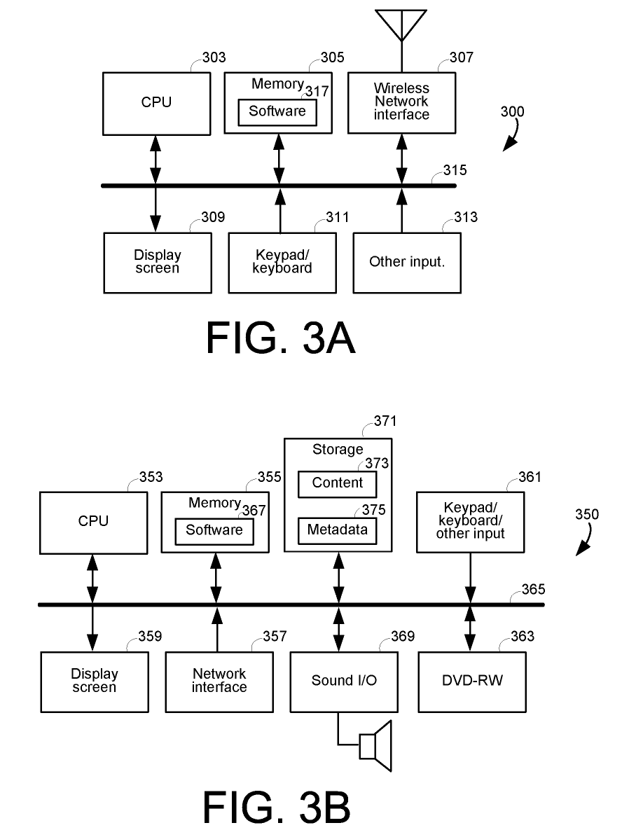

FIG. 3A shows a simplified block diagram of the architecture of another example device 300 that can operate as a remote control according to some embodiments of the present invention, and that can have a simple architecture, e.g., can be what we call a lightweight device. In such an arrangement, some or all of the data included in what we call the control database, e.g., the database 237 of code sets associated with various types and brands of media devices, e.g., storage/retrieval/input/playback devices that can be operated with the remote control, and the device parameters 241 are stored remotely in one or more remote servers. Also, metadata about the media content can be stored remotely. See the below description of the control server for one embodiment of so storing such data remotely.

The device 300 includes one or more processors, e.g., CPU 303, memory 305, a display screen 309, an user input keypad and/or keyboard 311, a wireless network interface 307, and in some embodiment, one or more other input devices shown as block 313. These elements are all coupled by a bus subsystem 315 that, for simplicity, is shown as a single bus 315. The memory includes logic, e.g., in the form of software 317 that when executed is operable to implement remote control features according to the present invention. The wireless network interface, in some embodiments, is an IEEE 802.11 wireless network interface. Other embodiments might include instead, or in addition other radio frequency wireless interfaces, e.g., Bluetooth, and/or an IR wireless link to a matching IR receiver or transceiver.

FIG. 3B shows a simplified block diagram of a server device 350, e.g., a PC that includes logic that when executed in the server device implements a control server embodiment coupled to a control point embodiment according to one or more versions of the present invention. The server device 350 includes one or more processors, e.g., CPU 353, a memory subsystem 355, optionally a display screen 359, optionally a user input keyboard 361, e.g., with a pointing device such as a mouse, a network interface 357, a storage subsystem 371, a DVD or CD player or player/recorder 363, a sound input/output device 369, and in some embodiments, one or more other input devices (not shown). These elements are all coupled by a bus subsystem 365 that, for simplicity, is shown as a single bus 365. Those in the art will understand whether one or more of the elements is present depends on the type of device. Therefore, many such devices will not include the display screen or the keyboard/pointing device 361. Also many such embodiments will not include the DVD/CD unit 363, or even the sound input/output device 369. Furthermore, if the device in FIG. 3B is a wireless media server, a wireless interface is included.

The memory subsystem 355 includes logic, e.g., in the form of software 367 that when executed is operable to implement the control server and control point features according to the present invention as described in more detail below.

In one embodiment, working in the context of UPnP, the software 367 is further operable to implement media server aspects of the present invention.

The storage subsystem 371 in one embodiment includes content 373 for playback, e.g., AV files. In one embodiment, working in the context of UPnP, the software 367 is further operable to implement media server aspects of the present invention. Furthermore, in one embodiment, the storage subsystem 371 further includes metadata 375 for the content, including metadata used to implement one or more features of the present invention, e.g., to include some of the graphic icons used in the remote control for different types of content.

An Example of Usage

In one example, a user buys content and wants it to be available to anywhere in the home whenever the user wants to playback the content. The user wants to be able to control playback from the point of view of the content in a manner that is intuitive and obvious to a human. Furthermore, the user wants to be able to control playback of any content from a personal device such as the remote control device 110.

One embodiment of the invention includes the feature that a user can select the particular item for playback, e.g., video content or audio content directly via the remote control 110 without regard to where or how that item for playback is sourced, e.g., without regard to whether the item is stored in the server computer 103, or in one of the other storage/retrieval/input/playback devices, or streamed via the Internet 125, or some other way. One embodiment of the invention includes the feature of personalization of the choices available. Furthermore, one embodiment of the invention includes the feature of selection of playback by location so that, for example, a user indicates his or her location and the item for playback, and the selected item for playback is routed to an appropriate storage/retrieval/input/playback device located in the indicated location. While a mechanism for channel selection is provided, also provided is a mechanism for selecting a program by name rather than by channel, e.g., a user can select to watch CNN and does not necessarily need to know the channel number CNN is on. Similarly for live audio, as an example, a user can select to listen to a particular DJ and does not necessarily need to know what radio station such a DJ is on.

Although the operation will be described in terms of a displayed user interface with which the user interacts by pressing the touch panel 233 or the buttons/wheel, in an alternate embodiment, the device 110 includes a microphone 256 and software for speech recognition such that the device can operate using spoken speech.

In one embodiment, a setup wizard guides users through installation making it easy to get going. This includes selecting an electronic program guide function for the user to have program guides automatically downloaded and available for all media content sources of interest. The setup wizard further includes automatic device discovery, defining or discovering locations for each device, and defining or discovering the capabilities of each device, including any required remote control codes.

Another feature included in some embodiments of the invention is that there is stored, e.g., on the remote control device as part of the device parameters 241, or in an alternate embodiment on a server, a database that specifies what controllable peripheral devices are connected at each location, and for each device, the device properties, such as the device's network address, playback capabilities, and so forth. Thus, in one embodiment of the invention, the location maps into one or more storage/retrieval/input/playback devices located at the location.

One embodiment of the remote control device 110 includes the ability to playback one or more forms of content, e.g., audio, video, or the like on its speaker 235 and/or display 216. Thus, in one embodiment of the invention, media content can be routed for playback on the remote control device 110 itself.

Other embodiments of the invention include the user interface. In one embodiment, a location selection screen is presented to the user for the user to indicate where playback is to take place. A default location is stored should the user fail to provide an indication of the location. The default location in one embodiment is the last selected location. In an alternate embodiment, the remote control device 110 includes automatic location determining. Therefore, via sensors located in parts of the house, one embodiment of the invention includes the feature of automatic discovery of location of the remote control device. Furthermore, one embodiment of the invention includes the feature of automatic discovery of devices at any indicated location.

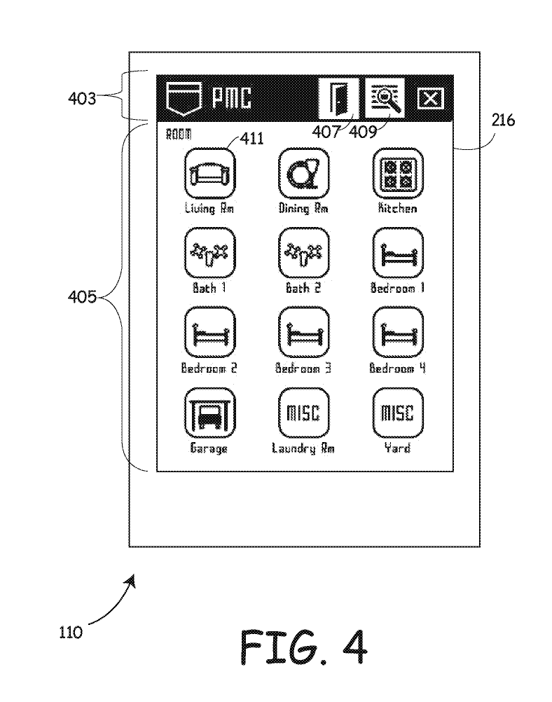

In the example described herein, manual location selection is assumed. FIG. 4 shows a simplified representation of the remote control device 10 and its screen 216. One embodiment of the invention includes the feature of presenting a screen that includes a common part 403. The common part includes a clickable icon 407 for opening media content, a clickable icon 409 for browsing for media content, and a clickable icon for closing the current screen. FIG. 4 shows the room start-up screen 405 that includes a set of icons each defining a particular location. For example, the living room is shown as icon 411 with a textual indication “Living Rm.” While not shown in the version of FIG. 4, in embodiments wherein the remote control device 110 is capable of playback, one location icon is the remote control device. The remote control itself is thus regarded as a location in such embodiments.

A user can now select an icon for playback. For example, suppose the user selects the living room for playback by clicking or touching the living room icon 411. Any selected media item(s) will then automatically be played back in a playback device in the living room. Furthermore, selections for playback will be only of media content that is playable on at least one of the devices in the living room.

In one embodiment, upon a user selecting a particular location, a browse location screen automatically appears. Suppose that after the living room is selected, a user requests a browse by clicking on the browse icon 409 in the common part of the screen.

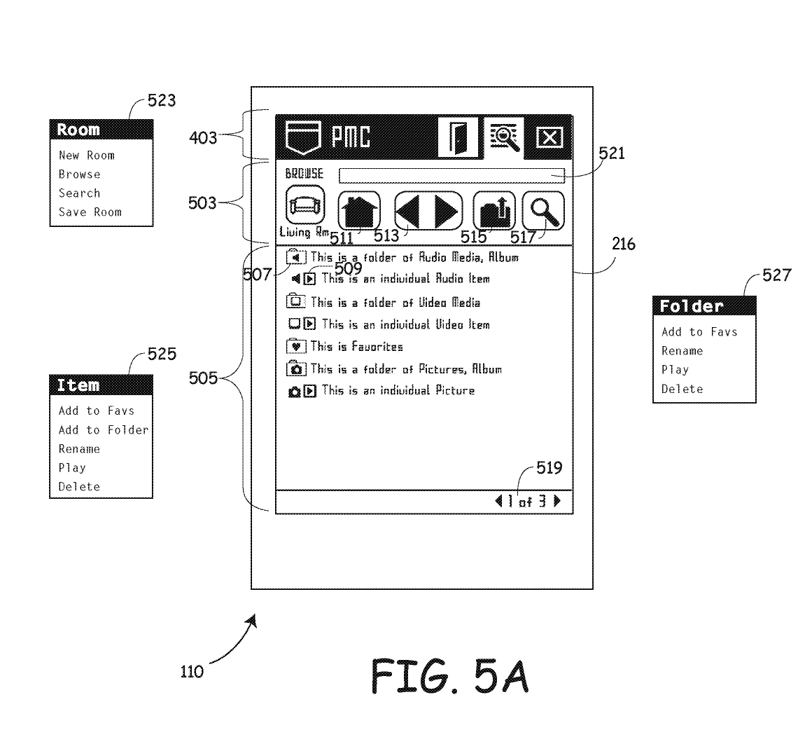

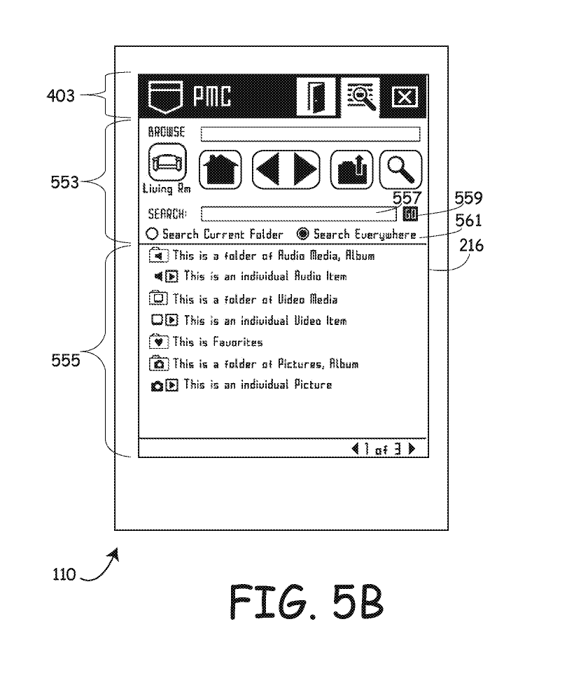

FIG. 5A shows a browse location screen display that is presentable to a user once the user has made a location selection. In FIG. 5A, the living room location is assumed. The display screen 216 includes the common section 403, a browse control part 503, and the content display 505. The content display 505 is in a form using folder icons, with indications on each folder, e.g., as an icon to indicate the type of media content items in the folder. Thus shown are folders for audio media content (audio folder 507), video media content, still images (photos) and also a favorites folder where selected folders and/or individual items are placed by the user. The content is arranged as a hierarchy as is common in media storage. Therefore, while in the example shown, the audio folder 507 shows only a single playable audio item, the audio folder 507 can contain a hierarchy of audio folders, as is common in file storage.

The user interface for browsing includes next to each item a mechanism for selecting the item for playback. In the example shown, an arrow icon, e.g., icon 509 on the audio item, is used to provide for starting playback

As is common in browser displays of folders, double clicking on a folder can cause the browser display 505 to move down one level in the display.

The browse control part 503 of the user interface includes a control 511 for showing the room selection display, a control 513 for moving backwards or forward in the sequence of browse screens, e.g., if the previous display was one up in the hierarchy, invoking the back moves one back to that display. Also included is a control 515 for saving an item selected in the browse screen 505. Also included is a search control 517 for initiating a search.

In addition when one has selected either a folder, an item, or room, e.g., by clicking or otherwise invoking a folder icon, an item icon, or the room icon (in this case, the Living Room icon in the browse control part 503), a user may also click or otherwise invoke pull down selection displays. When an item is selected, a pull down list of actions 525 for the item includes, in one embodiment, adding the item to the Favorites folder, adding the item to another folder, renaming the item, playing the item, or deleting the item. When a folder is selected, a pull down list of actions 527 for the folder includes, in one embodiment, adding the folder to the Favorites folder, renaming the folder, playing the items contained in the folder, or deleting the folder and, as an option presented to the user, the items therein. When the location icon is selected, a pull down list of actions 523 for the room includes, in one embodiment, selecting a new room or location, browsing in the selected location, searching for item(s) playable in the location, or saving the room in the database of locations.

In one embodiment, the user is also presented with the ability to enter text for an item via a text entry window 521.

Note that in general, there may be several browse screens at any level. In the screen shown in FIG. 5A, the first of three screens is shown. A control 519 is provided for the user to move to the next or previous screen. The control 519 includes a display of which page of a multi-page/multi-screen display is being displayed.

One embodiment of the invention includes the ability to search for media content playable at a selected location. By invoking a search, e.g., using the search icon 517 or by the pull down menu 523, one can invoke the search function. FIG. 5B shows a search screen display that is presentable to a user when the user invokes the search function from the search icon 517 or from the pulldown menu while in the room viewing mode, e.g., browsing a room. In FIG. 5B, the living room location is assumed. The display screen 216 includes the common section 403, a search control part 553 that in one embodiment, includes the same controls as the browse control part 503 of FIG. 5A but in addition has a window 557 for entering search term(s), and a button 559 to invoke the search for that term/those terms. In addition, the search control part 553 includes provision 561 for the user to indicate whether the search is to be performed within a currently selected folder or everywhere.

In one embodiment, a content display 555 is included that has the same content as the browse content display 505. Thus, in one embodiment, the search screen adds elements to the browse screen shown in FIG. 4B.

In another embodiment, the browse screen is that of FIG. 5B and includes provision for search.

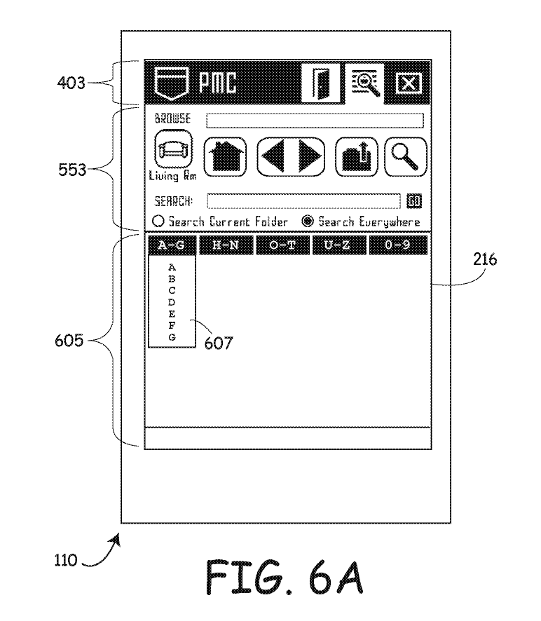

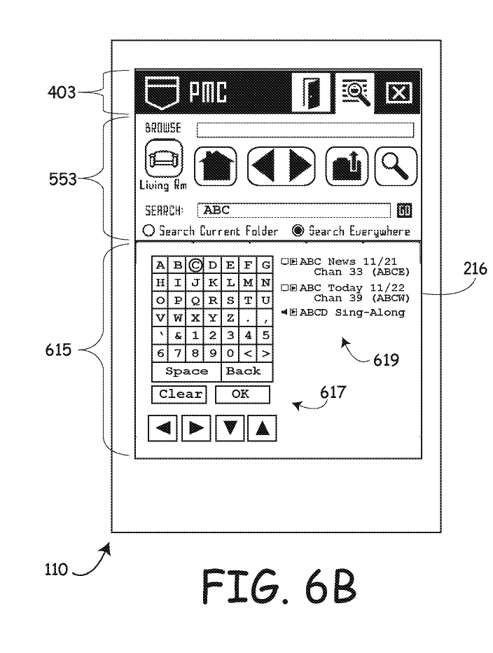

FIG. 6A shows a screen that, in one embodiment, provides for alphanumeric input, e.g., of search terms. Several alternate mechanisms for entering alphanumeric data are possible and known. In the embodiment of FIG. 6A, the alphanumeric input part 605 shows ranges of alphanumeric characters. Invoking, e.g., touching any region showing a range causes a pull-down menu 607 to appear with each alphanumeric character in the range.

FIG. 6B shows one alternate form of alphanumeric entry 615 in which an image 617 of all alphanumeric characters is presented together with some control buttons. Some of the buttons are for navigating through the characters. A user selects one character at a time.

Other alternate forms of alphanumeric entry are known, and such methods may be used in alternate embodiments of the invention.

Referring now to FIG. 6B as an example, every time a user selects another alphanumeric character, a list of playable items 619 that start with such a character is presented. In the example shown, A, B, and C have been entered in that order. At this stage, in the example, three items are available for playback: two ABC News television recordings, and a song. The user can now select on of these for playback, moving a selection icon, shown in the C, to the item using the arrow buttons provided in the user interface.

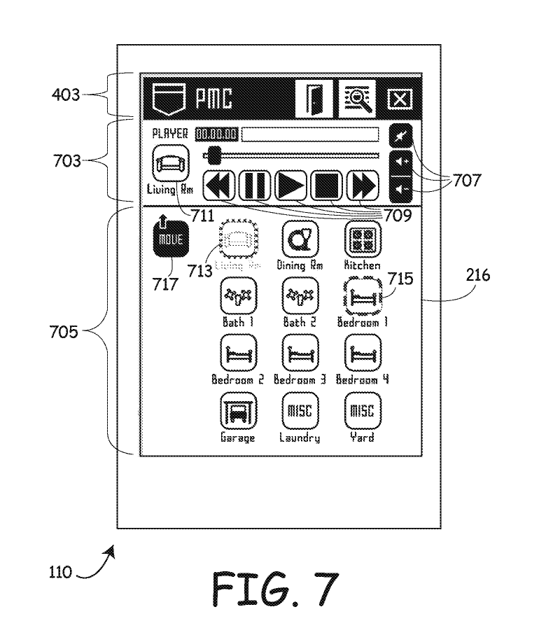

FIG. 7 shows a location playback control screen when an item is being played, e.g., after a user invokes a play item by, e.g., activating the play control 509 (See FIG. 4B) or by some other method. FIG. 7 shows a browse location screen display that is presentable to a user once the user has made a location selection. In FIG. 7, the living room location is assumed. The display screen 216 includes the common section 403, and a player control part 703. The player control 703 includes volume and mute controls 707, controls 709 for forward, reverse, stop, pause, fast forward and fast reverse, a room display user interface 711 indicating in which room the content is being played, and other content displays like a item being played title display, time display and progress display, as is common in playback user interfaces.

In one embodiment, the room display user interface 711 also includes a room control clickable or otherwise invokable by the user. Invoking the room control 711, in one embodiment, causes the method to display a screen 705 that shows all the rooms in the house, with the currently selected room highlighted in some manner. In FIG. 5B, the currently selected room is shown “grayed” out. In addition, all the rooms in which an item is currently being played are displayed highlighted, e.g., Bedroom 1 and the Living room are shown with highlights, as indicated in FIG. 7 by the thick broken outlines in the Living room icon 713 and Bedroom 1 icon 715. In one embodiment using a color display, the indications are with the outlines shown highlighted in color. Thus, one embodiment of the invention includes the feature of a user being presented a display of all locations with an indication of which locations have a media content item being played back. Furthermore, one embodiment of the invention includes the feature of a user being presented a display of locations for playback, with the selected location highlighted. Furthermore, one embodiment of the invention includes the feature of a user being presented a display of locations for playback, with an indication of who is playing back at each location, e.g., the ownership of playback. In FIG. 7, such ownership indication is by the type of outline—short broken lines for the present owner at the Living Room icon 713 and longer broken lines for a second user for the Bedroom 1 icon 715. In an actual color display, different colors are used in one embodiment, and another distinguishing features, e.g., shape is used in an alternate embodiment.

In some embodiments of the invention, the remote control operates according to a hierarchical privilege system, e.g., a parental control system, so that normally, a user has privacy in selecting what is being played, so that another user may not be able to remotely access such information, and also so that another user may not be able to remotely control such playback, but with some users having greater privilege than others, so that, for example, parents can control playback by children (but not vice-versa), including controlling what content is playable. In such an embodiment, the method operating in the server includes accepting from the remote control an indication of the user, e.g., a user ID or password or both. The server includes information on a set of users, e.g., a set of User ID, and passwords, properly encrypted, and also the privilege for the set of users.

In one simple implementation, the hierarchical privilege system is a parental control system with two levels, parent and child. A parent needs to provide to the system a password. A child is a user who does not provide the password. A parent may leave a remote control device “open” or locked such that a password is needed to unlock the remote control device.

In a more sophisticated version, more than two levels are provided in the hierarchy. Privacy is accorded such that a user has privacy, e.g., of what is played from other users at the same or lower level in the hierarchy. Other versions also are possible, as would be clear to those in the art.

In one embodiment, presenting the location playback display 705 also includes presenting a control 717 to the user for moving the media item currently being played to another room. In one embodiment, to cause playback of the currently playing item in a new location, the user invokes the Move control 717 followed by one of the locations, e.g., another room, or in an embodiment in which the remote control 110 can play back media content item(s), the remote control. The method reads the invoked control and location, and routes the media content item(s) to that location.

In one embodiment, the user's invoking one of the location icons that is highlighted, that is, where there is some media content item being played—an “active” location—causes the playback control 703 to change to that location, if the present user has permission for playing back in that location and the media content item currently being played back in that location. Thus, the method receiving an indication of a user's having invoked an active location causes the method to ascertain whether or not the present user has permission for the invoked location and the media item being played in the location, and if so, causes a control display 703 for that location to be displayed to the user on the remote control, and causes an updated playback location display 705 to be displayed on the remote control device 110 with the new location grayed out to indicate it is the presently playing location, and the previous selected display no longer grayed out, but still shown as “active.”

Some embodiments of the invention include the feature of preventing a user from playing back an item at a busy location. The remote control device 110 is programmed to not permit such an occurrence. Furthermore, in an embodiment that includes a hierarchical privilege system, one embodiment of the invention includes the feature of a user having higher privilege than a second user playing an item back at a selected location may override such playback by selecting to play back another item at the selected busy location. Such a user selecting to play back at a busy location is presented with a message on the display of the remote control device 10 that an item is being played back at the selected location, and provided with an override control to override such a playback by another user is the user has higher priority than the other user.

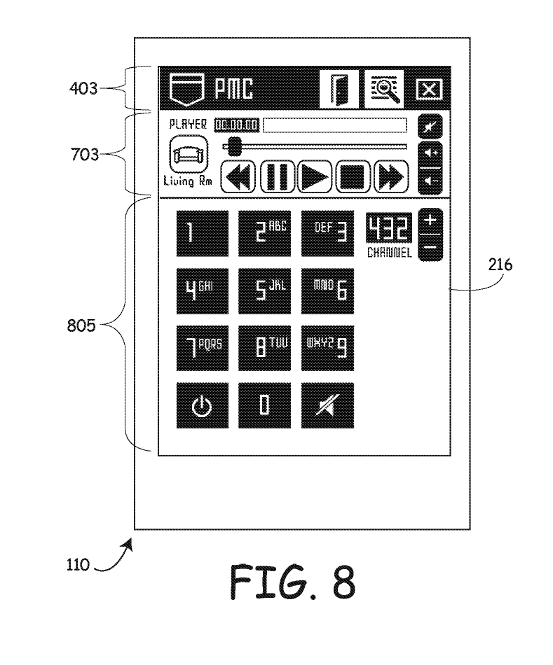

Some embodiment of the invention include one or more alternate mechanisms for a user to select media content item(s) other than the browse displays of FIG. 4B or FIG. 7, or the search of FIG. 6A or 6B. One example is selection by channel selection. In one embodiment, the user indicates a desire for a channel selection screen. The method receives the user command to display a channel selection display and causes a channel selection display to be displayed. FIG. 8 shows a screen 216 with the common control part 403 and an example channel selection display 805 that includes channel selection controls. The method, detecting that the user has invoked a channel, plays back the media content on that channel at the selected playback location. As shown in the display of FIG. 8, once the channel is selected and playback commenced, in one embodiment, the location playback control 703 is displayed on the screen to provide control and feedback for playback of the selected media content and playback location.

In one embodiment, the items for playback are stored with metadata that describes one or more characteristics of the media content, e.g., genre, performers, rating (for parental controls), ownership, and so forth. In one embodiment such data provides for searching by one or more of the metadata categories rather than simply by name. The metadata includes a plurality of fields for the one or more characteristics of the media content.

Some embodiment of the invention include the feature of browsing and controlling the viewing of digital (still) images on a selected screen, e.g., a TV screen at a selected location. The remote control device 110 provides for such playback, e.g., as a “slide show” according to which selected images are displayed sequentially, or, at a user option, at random. Furthermore, some embodiments of the invention include providing one or more mechanisms, using the remote control device 10, for a user to see a preview of the images for display on a selected screen, e.g., a TV screen at a selected location, so that the user may decide, ahead of display on the selected screen, whether or not to display a particular image. In one embodiment, the remote control device is programmed to display to the user on the screen of the remote control, a thumbnail preview of the next image in the sequence prior to display at the selected location, e.g., while the present image is being displayed. In one embodiment, the remote control device is programmed to display a control to skip displaying on the selected screen the currently-previewed next image, and in one embodiment, the remote control device is programmed also to display a control to display the currently-previewed next image for a longer period of time on the selected screen than are those images not so selected for longer display.

While a simple screen user interface has been shown, in an alternate embodiment, a rotary scroll control and display is used. See for example, U.S. Patent Application No. US 20030076301 to Tsuk et al., titled METHOD AND APPARATUS FOR ACCELERATED SCROLLING; U.S. Patent Application US 20030095096 to Robbin, et al. titled METHOD AND APPARATUS FOR USE OF ROTATIONAL USER INPUTS; U.S. Patent Application No. US 20040055446 to Robbin, et al. titled GRAPHICAL USER INTERFACE AND METHODS OF USE THEREOF IN A MULTIMEDIA PLAYER for details of alternate user interfaces. The contents of US 20030076301, US 20030095096, and US 20040055446 are incorporated herein by reference. The knowledge therein is publicly available to those in the art.

For details of an alternate embodiment of how data is locally storable for later searching for media content that is located on a server connected via a network is available in U.S. Patent Application US 20040215611 to Jawa, et al., titled ACCESSING MEDIA ACROSS NETWORKS. The contents of US 20040215611 are incorporated herein by reference. The knowledge therein is publicly available to those in the art.

Some embodiments of the invention include on-the-fly transcoding of data. Upon the method detecting a request to playback media on a location, the method ascertains whether or not the selected media content item(s) is/are directly playable at the location, and if not, whether transcoding the data of the selected media content item would lead to transcoded data that is playable at the location. If so, then the method includes causing transcoding of the data of the selected media content item to a form playable at the selected location, and routing the transcoded version of the data to the selected playback location.

Transcoding between different pictorial, video-only, audio-only, and audiovisual data is known to those in the art. See for example, U.S. Patent Application US 20050132264 to Joshi, et al., titled SYSTEM AND METHOD FOR INTELLIGENT TRANSCODING for one such method. The contents of US 20050132264 are incorporated herein by reference. Real-time transcoding includes the use of a real-time transcoding engine. Such an engine may be implemented in hardware, software, or a combination thereof.

Some embodiments of the invention include automatic providing of an option of delivery of media content over the Internet. If as a result of a search, the method determines that the searched for item is not available locally, e.g., in server 103, a search is initiated over the Internet 125 to determine whether or not the selected item is available for download and/or playback over the Internet. If yes, then in one embodiment, the option is presented to the user of purchasing playback and/or downloading of the selected item.

Universal Plug and Play

Some embodiments of the invention operate with devices that conform to the Universal Plug and Play standard (UPnP).

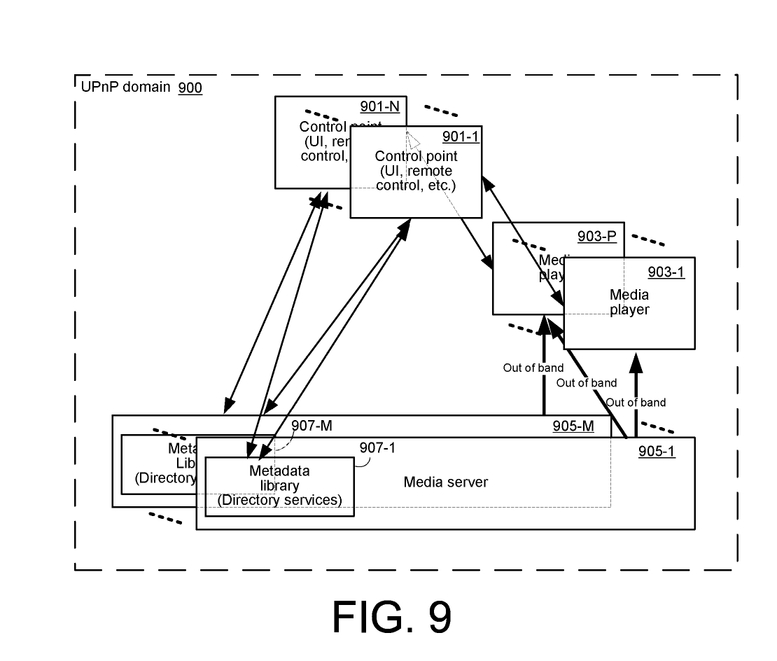

FIG. 9 shows a conventional AV architecture according to the UPnP standard. The example network shown in FIG. 1B, for example, can operate under this arrangement. Note “control server” as shown in FIG. 1B is not a component of a prior art UPnP AV architecture.

According to conventional UPnP AV architecture, three distinct entities are involved: 1) a control point, 2) a source of media content, called a “media server”, and a sink for the content, called a “media renderer,” “media player,” or “media playback device” herein. While in the this disclosure, all three entities are often described as if they were independent devices on the network, and such a configuration is actually possible, e.g., a VCR (the media server), a control device, e.g., coupled to a remote control (the control point), and a TV (the media player), those in the art will understand that the UPnP AV architecture supports arbitrary combinations of these entities within a single physical device.

FIG. 9 shows a conventions UPnP domain for AV that includes a number denoted N of one or more control points 901-1, . . . , 901-N, a number denoted P of one or more media players 903-1, . . . , 903-P, and a number, denoted M of one or more media servers 905-1, . . . , 905-M, respectively. The individual media servers and the media players do not directly interact with one another. Rather, each control point interacts with one or more media servers and/or one or more media players. For playback, for example, a control point sets up a media server and a media player using UPnP to initialize and configure both devices so that desired content is transferred from the media server to the media player, or in another example, from one media server to another media player. The content is transferred from one device to the other using an “out-of-band” transfer protocol; the control point is not directly involved in the actual transfer of the content. Neither the media server nor the media player invoke any UPnP actions to the control point. However, if needed, the media server and/or media player may send event notifications to the control point in order to inform the control point of a change in the media server's and/or media player's internal state.

For more details on UPnP AV transfers, see for example, “UPnP AV Architecture:0.83, For UPnP™ Version 1.0” from the UPnP Forum, www.upnp.org, dated Jun. 12, 2002.

Devices may have their own control points. For example, it is common for playback devices to have a dedicated control point, e.g., a control point sold with, even incorporated with the playback device, and dedicated to controlling the playback device.

Each media server is used to locate content that is available via the network, e.g., the example network shown in FIG. 1B. Media servers include a wide variety of devices including VCRs, DVD players, satellite/cable receivers, TV tuners, radio tuners, CD players, audio tape players, MP3 players, PCs, etc. A media server's primary purpose is to allow control points to enumerate, (e.g., browse or search for) content items that are available for the user to play back. Each media server contains a ContentDirectory service, a ConnectionManager service, and an optional AVTransport service, depending on the supported transfer protocols.

Some media servers are capable of transferring multiple content items at the same time, e.g. a hard-disk-based audio jukebox may be able to simultaneously stream multiple audio files to the network. In order to support this type of media server, the ConnectionManager assigns a unique identifier, called a ConnectionID to each “connection,” e.g., each stream that is made. This ConnectionID allows other control points, e.g., the control point according to an embodiment of the present invention, to obtain information about active connections of the media server.

Each media server 905-1, . . . 905-M includes a service called a ContentDirectory service, or simply “directory service” herein, that provides a set of actions that allow a control point to enumerate the content that the media server can provide to the network. The primary action of directory service is called Browse( ), another is called Search( ) herein and allows a control point to obtain or search for detailed information about each content item that the media server can provide. This information is called “metadata” herein. Each media server 905-1, . . . 905-M is thus shown to include a respective metadata library 907-1, 907-M that is used to provide the directory service for the respective media server. While usually metadata library is collated n the same device as the content itself, this need not be the case, as long as there is some link, e.g., pointer from one to the other. Metadata includes properties such as the content type, name, artist, date created, size, etc. Additionally, the metadata identifies the transfer protocols and data formats that are supported by the media server for that particular content item. The control point uses this information, for example, to determine if a given media player is capable of rendering that content in its available format.

Each control point is responsible for discovering AV devices (media servers and media players) in the network using UPnP's discovery mechanism, media servers and media players in the home network are discovered. Each control point also is responsible for locating desired content using the Directory services Browse( ) or Search( ) actions. The information returned by Browse( )/Search( ) includes the transfer protocols and data formats that the media server supports to transfer the content to the home network. Each control point also is responsible for obtaining each media player's supported protocols/formats.

Those in the art will understand that in a network environment such as shown in FIG. 9 that includes a plurality of control points, i.e., N>1, one or more media servers, so M≧1, and a plurality of media players, i.e., N>1, in order for each control point to properly function, e.g., be able to control playback of media content on each playback device, each control point needs to discover each device in the network, and further, maintain the state and capabilities of each device in the network. A problem can occur that the state known to the different control devices is not the same, so that errors can occur. Furthermore, in some networks, it takes some time for the different control points to fully discover devices in the network and to become synchronized to each other. Furthermore, in order for a control point to maintain information on each device, the control points possibly needs to be able to operate a complex set of user interfaces for the various devices, and maintain information on, for example, the content in each media server. Therefore, a typical control point would need to have processing power and memory or other storage sufficient to carry out these functions efficiently.

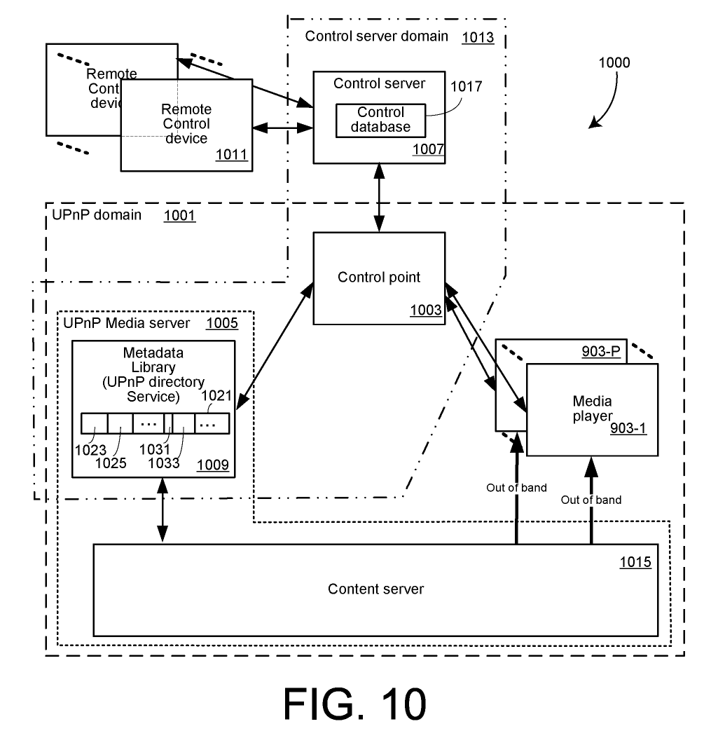

FIG. 10 shown a simple block diagram of UPnP network arrangement 1000 that includes an embodiment of the present invention. The network arrangement 1000 includes one and only one control point 1003 in the UPnP domain. The control point includes the ability to discover devices and obtain state information from each device. However, because there is one and only one control point for all devices on the network, there is not the possibility of different control points maintaining different state information. Coupled to the control point is a control server 1007 that maintains information on different devices, such as the state of the network, e.g., each device on the network, on the different controls required for each device, user interfaces, and so forth. The control server 1007 is typically but not necessarily co-located with the control point 1003 such that the combination of the control point 1003 and the control server 1007 is in the form of hardware, software, and data in a processing system. In the example network shown in FIG. 1B, the control server can be in such devices as the media center PC 177, the network attached storage 179, or the wireless media adapter 185. One function of the control server is to establish connection with one or more remote control devices 1011. In one embodiment, at least one remote control device 1011 is coupled to the control server 1007 via an IEEE 802.11 wireless network, e.g., the network 157 in the example arrangement of FIG. 1B, in which case the remote control devices in communication with the control server 1007 are one or more of devices 165, 167, and/or 169. The remote control device in one embodiment has the general architecture illustrated in FIG. 3A.

For each particular remote control device, the combination of the particular remote controller, corresponding parts of the control server 1007, and the control point 1003 perform functions that previously might have been performed by a particular one of the plurality of control points 901-1, 901-N in the system shown in FIG. 9. However, in one embodiment, each remote controller can be a “lightweight” device with relatively little local memory and with relatively little computational power. The control server 1007 maintains information on how each device is controlled, including how each playback device is controlled, user interface elements for the remote controllers, and so forth. In one embodiment, the control server includes a database of information, called the control database 1017 herein. The control database 1017 maintains information on the network, including the devices at each location, the capability of each device, and so forth, and further information on each remote control device 1011 with which the control server is in communication.

The control server 1007 and the one and only control point form a control server domain 1013 for the UPnP domain 1001. In one embodiment, the control server and control point operate in a processing system such as shown in FIG. 3B, as software executing on the processor of the processing system.

Thus, as stated above, because there is only one control point, only one device needs to maintain state of the overall UPnP network. There is thus less chance of error than with the architecture shown in FIG. 9. Furthermore, the architecture shown in FIG. 10 is compatible with standard UPnP. The media server and media playback devices typically would not need to be modified to work with this architecture, except of course, in the case of a device that for the architecture of FIG. 9 came with a dedicated control point, that control point's function would be carried out by the control server 1007 in combination with a remote control unit 1011 and the control point 1003 in the system shown in FIG. 10.

Only one media server is shown in FIG. 10. In this description, it will usually be assumed that there is only one metadata library, and in alternate embodiments, there is a plurality of metadata libraries. Those in the art will understand how to modify the description herein for the case of a plurality of metadata libraries. The directory service uses a metadata library 1009 that includes the metadata on one or more content items. The metadata library can be on the same or a separate device from where the content server's content items are stored. FIG. 10 shows the content items in a content server 1015. The content server 1015 and metadata library 1009 together form a media server 1005 in the UPnP context.

In one embodiment, the control server 1007 is coupled to the metadata library of each media server 1005. In one embodiment, the metadata library 1009 is part of the control server domain 1013 and operates on the same device, e.g., server computer as the control server 1007 and control point 1003. Those in the art will understand that in alternate embodiments, the metadata library is on a different device, and the coupling between the control server 1007 and the metadata library 1009 is via a network.

One embodiment of the control point includes an API for the control server to enable the control point to accept commands from the control server, provide the status of the network ad of one or more devices on the network to the control server.

In one embodiment, the control server and control database are substantially as described in U.S. Pat. No. 7,127,305 to inventor Palmon titled METHOD AND APPARATUS FOR UNIFIED CONTROL OF MULTIPLE DEVICES. The contents of U.S. Pat. No. 7,127,305 are incorporated herein by reference.

One implementation of the control point 1003 and the control server 1007 is in the form of logic, e.g., software, possible in combination with hardware. The logic is embodied on one or more tangible computer readable media. The logic includes control point logic, that, when executed on one or more processors of a processing system is operable to implementing the control point 1003. The logic also includes control server logic, that, when executed on one or more processors of a processing system is operable to implementing the control server 1007. When executed in a processing system that is coupled to a network, the control point logic is operable to communicate with one or more media players—players 903-1 to 903-P in the case of P media players—and/or with one or more media servers, e.g., server 1005. Each media player and media server is coupled to the network and conforms to a standard that uses a standard communication control protocol. In the example described herein, the standard is the UPnP standard, and the communication protocol is the UPnP protocol. The control point logic is further operable when executed to control any one of media players and any one of the media servers using the standard communication control protocol, e.g., UPnP. The control protocol, e.g., UPnP is able to cause playback at a selected media player of a selected item of content of a selected media server. Playback includes transfer of the data of the selected item of content from the selected media server to the selected media player, e.g., using an out-of-band protocol.

The control server logic is operable when executed on a processing system coupled to the network to implement a control server, e.g., control server 1007 coupled to the control point, In particular, the control server logic is operable when executed to access a control database, e.g., database 1017 that includes information for controlling one or more of the media players and media servers. The control server logic is further operable when executed to receive data from one or more remote control devices, e.g., devices 1011, and to interpret data received from a selected remote control device and cause the control point module to control any one of media players and/or any one of the media servers according to the received data.

In one version, the control server logic is further operable when executed to send data to the selected remote control device and further able to interpret data from the control point module and send corresponding data to the selected remote control device.

From the user point of view, operating a remote control device is as described above in the section titled “An Example of Usage.” The content search and browse function is provided by the UPnP control point 1003 interacting with the media server 1005, and the control server 1007/remote control device 1011 communicating with the control point 1003.

Lightweight Remote Control Device

One embodiment of the invention includes presenting to the user a user interface that includes elements for controls that are common to many media content types. We call such controls “common controls,” and the corresponding user interface elements “common under interface elements.” As an example, the user interface for many different playback devices includes a “play” button, a stop button, a fast forward button, and a “pause” button. Other elements included in a different user interfaces may be dependent on the type of media content and/or type of media playback device. For example, a user interface for video content might include a “zoom” control. A user interface for a TIVO™ DVR device is known to include a “thumbs-up” control to indicate to the TIVO system that the viewer likes the program being played, i.e., positively rates this program, and a “thumbs-down” control to indicate to the TIVO system that this user does not like this program, i.e., negatively rates this program. Each of these controls may be pressed a number of times to increase the “I like” factor—the positive vote—by again pressing the “thumbs-up” control, or to decrease the “I like” factor by pressing the “thumbs-down” control. In this manner, any program may be rated from three net positive ratings—three net “thumbs-up”s—to a net of three negative ratings—three net “thumbs-down”s. However, such “thumbs up and “thumbs down” controls are typically not common to other types of media devices. Similar, a “zoom” button may not be appropriate for audio and/or an audio-only playback device. We call such content-specific controls “content-specific controls.”

In one embodiment, the metadata library 1009 that includes metadata on the content items in the media server 1005 in the UPnP domain 1001, e.g., in the content server 1015 includes, for at least one content item, references to one or more content-specific user interface elements for content-specific controls. FIG. 10 shows one metadata 1021 on one item. Such metadata 1021 includes a plurality of fields, and several fields 1023, 1025, 1031, 1033, . . . are shown. In this example, the field 1033 includes a reference to one or more content-specific user interface elements for content-specific controls for the content corresponding to the metadata 1021. These, together with the user interface elements for the content-specific controls are presented as controls on the user interface of the remote control. In one embodiment, the metadata 1021 in the metadata library 1009 for a particular item of content include an indication of whether or not controls other than the common-controls are sufficient, e.g., an indication in one of the fields, in the example field 1031. In another embodiment, the indication in the form of a pointer to one or more graphic elements stored in one or more locations in the network, e.g., locally in the same device as the metadata library 1009, in the control database 1007, or in the content server 1015, or some other server. In another embodiment, the pointers are used to retrieve the graphic elements from a remote server if the graphic elements are not stored locally.

Thus, according to one embodiment, the metadata for a content item includes one or more fields, e.g., 1031, 1033, that optionally include information on one or more content-specific controls to add to the user interface for playing back the media content, including the action to perform, and an indication of the graphic to include in the user interface.

In an alternate embodiment, rather than an indication of how to retrieve the graphic, the metadata includes the graphic information to use, e.g., an icon to use.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computer” or a “computing machine” or a “computing platform” may include one or more processors.

The methodologies described herein are, in one embodiment, performable by a machine which includes a one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein also encompasses a storage system such as a disk drive unit. The processing system in some configurations may include a sounds output device, and a network interface device. The memory subsystem thus includes a carrier medium that carries machine readable code segments (e.g., software) including instructions for performing, when executed by the processing system, one of more of the methods described herein. The software may reside in the hard disk, or may also reside, completely or at least partially, within the RAM and/or within the processor during execution thereof by the computer system. Thus, the memory and the processor also constitute carrier medium carrying machine readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagram(s) only show(s) a single processor and a single memory that carries the code, those in the art will understand that many of the components described above are included, but not explicitly shown or described in order not to obscure the inventive element or combination of elements. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer program that executes on a processing system, e.g., a one or more processors that are part of a remote control device implemented on a mobile platform such as a PDSA or mobile phone. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, some embodiments of the present invention may take the form of a method, an entirely hardware embodiment, an entirely software embodiment or an embodiment combining software and hardware parts. Furthermore, the present invention may take the form of carrier medium (e.g., a computer program product on a computer-readable storage medium) carrying computer-readable program code segments embodied in the medium.

The software may further be transmitted or received over a network via the network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by the machine and that cause the machine to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to include, but not be limited to, solid-state memories, optical and magnetic media, and carrier wave signals.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may represent different embodiments. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive elements. This method of disclosure, however, is not to be interpreted as reflecting an intention that the claimed invention requires more features than are expressly recited in each claim. Rather, as the following claims reflect, inventive elements lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems, wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. An apparatus comprising:
a processor;
a display screen coupled to the processor;
an input device operable to accept user input from a user; and
memory coupled to the processor, the memory including logic operable when executed by the processor to solicit information from a user, the logic having access to information regarding operation of a plurality of controllable devices that are remote from the apparatus, information regarding content for playback, and information regarding controls available for each respective controllable devices; and the playback capabilities of each controllable device,
wherein the logic is further operable when executed by the processor to generate a visual display of a user interface on the display screen that includes set of locations where there are one or more playback devices, such that a user can select one of the different locations for playback using the input device, and further select one or more items of content for playback,
such that as a result of accepting user input a content item for playback at the selected location, and an indication to playback the selected content item, the remote control device causes playback of the content item at the selected location.

2. An apparatus as recited in claim 1, wherein the user interface that includes a set of locations where there are playback devices includes an indication of the last selected location, such a last location is the default location for playback if the user does not change the selected location.

3. An apparatus as recited in claim 1, wherein the logic is further operable when executed to access a database of mappings of which playback devices are available at each location.

4. An apparatus as recited in claim 1, wherein the logic is further operable to provide for the user a mechanism to select from a set of content items, the mechanism to select enabling selecting only content items that are playable at the one or more selected locations.

5. An apparatus as recited in claim 1, wherein the logic is further operable to provide for the user a mechanism to select from a set of content items, and wherein the providing for the user a mechanism to select from a set of content items for playback at a particular location displays a browse location screen that includes content playable at the particular selected location.

6. An apparatus as recited in claim 1, wherein the logic is further operable to provide for the user a mechanism to select from a set of content items, and wherein the providing for the user a mechanism to select from a set of content items for playback at a particular selected location includes a mechanism for the user to search for content items playable at the particular selected location.

7. An apparatus as recited in claim 1, wherein the logic is further operable to provide for the user a mechanism to select from a set of content items, and wherein the providing for the user a mechanism to select from a set of content items for playback at a particular selected location includes a mechanism for the user to enter text.

8. An apparatus as recited in claim 1, wherein the logic is further operable when executed to provide for the user a set of controls for controlling payback of a particular content item as a result of the user selecting the particular content item.

9. An apparatus as recited in claim 8, wherein the providing for the user a set of controls for controlling payback of the particular content item includes providing for the user a subset including content-specific controls, such that the logic is operable when executed to combine a set of common user interface items with the user interface elements for the content-specific controls to form a user interface for playback of the particular content item, and wherein the user interface for playback of the particular content item depends on one or both of the type of content item and/or the type of playback device for the content item.

10. An apparatus as recited in claim 1, wherein the logic is further operable when executed to display on the screen of the remote control a room display interface in which is indicated in which locations a selected media content item is being played.

11. An apparatus as recited in claim 1, wherein the logic further is operable, when executed, to provide a mechanism for the user to enter a user identity, such that the content playable by the user is according to a hierarchical privilege system.

12. An apparatus as recited in claim 1, wherein the logic further is operable, when executed, to:
ascertain whether or not a particular selected item of content is directly playable at a particular selected location,
further ascertain, in the case it is ascertained that the data is not directly playable, whether transcoding the data of the particular selected item of content would generate transcoded data that would be playable at the particular selected location; and
in the case it is ascertained that the generated transcoded data would be playable, causing transcoding of the data of the selected media content item to a form playable at the particular selected location.

13. A method comprising:
causing a screen of a remote control device to display a user interface that includes a set of locations where there are one or more playback devices and one or more controls operable by a user of the remote control device to select one or more of the locations for playback;
receiving from the remote control device a user selection of one or more locations for playback;
causing the remote control device to provide for the user a mechanism to select from a set of content items for playback at the selected one or more locations; and
receiving from the remote control device a user selection of one or more of the set of content items and an instruction to playback the selected one or more content items,
such that as a result of user's selecting to playback the one or more content items using the remote control device, playback of the selected one or more content items occurs at the selected more locations.

14. A method as recited in claim 13, wherein the user interface that includes a set of locations where there are playback devices includes an indication of the last selected location, such a last location is the default location for playback if the user does not change the selected location.

15. A method as recited in claim 14, wherein the location of the remote control device is automatically determined, such that the default location for playback, if the user does not change the selected location, is the automatically determined location of the remote control device.

16. A method as recited in claim 13, further comprising;
accessing a database of mappings of which playback devices are available at each location.

17. A method as recited in claim 13, wherein the mechanism to select from a set of content items enables only selecting content items that are playable at the one or more selected locations.

18. A method as recited in claim 13, wherein the providing for the user a mechanism to select from a set of content items for playback at a particular location displays a browse location screen that includes content playable at the particular selected location.

19. A method as recited in claim 13, wherein the providing for the user a mechanism to select from a set of content items for playback at a particular selected location includes a mechanism for the user to search for content items playable at the particular selected location.

20. A method as recited in claim 13, wherein the providing for the user a mechanism to select from a set of content items for playback at a particular selected location includes a mechanism for the user to enter text.

21. A method as recited in claim 13, wherein the method comprises:
as a result of receiving from the remote control device a user selection of a particular content item, causing the remote control to provide for the user a set of controls for controlling payback of the particular content item.

22. A method as recited in claim 21, wherein the providing for the user a set of controls for controlling payback of the particular content item includes providing for the user a subset including content-specific controls, such that the remote control device is able to combine a set of common user interface items with the user interface elements for the content-specific controls to form a user interface for playback of the particular content item, and wherein the user interface for playback of the particular content item depends on one or both of the type of content item and/or the type of playback device for the content item.

23. A method as recited in claim 21, wherein the providing for the user a set of controls for controlling payback of the particular content item includes causing the remote control device to display graphic elements for control of playback that includes common controls stored in the remote control device and content-specific controls, wherein graphic elements for the content specific controls are stored outside the remote control device.

24. A method as recited in claim 13, further comprising:
causing the remote control to display on the screen of the remote control a room display interface in which is indicated in which locations a selected media content item is being played.

25. A method as recited in claim 13, wherein the remote control device includes a mechanism for a user to enter a user identity, such that the content playable by the user is according to a hierarchical privilege system.

26. A method as recited in claim 25, wherein the hierarchical privilege system is a parental control with a two level hierarchy.

27. A method as recited in claim 25, wherein the hierarchical privilege system is operable to accords privacy to a user against any other user at the same or lower level in the hierarchy.

28. A method as recited in claim 13, further comprising:
ascertaining whether or not a particular selected item of content is directly playable at a particular selected location;
in the case it is ascertained that the data is not directly playable, further ascertaining whether transcoding the data of the particular selected item of content would generate transcoded data that would be playable at the particular selected location; and
in the case it is ascertained that the generated transcoded data would be playable, causing transcoding of the data of the selected media content item to a form playable at the particular selected location.

29. Logic embodied on one or more tangible computer readable media, the logic for execution in one or more processing systems that are coupled to a network, the logic comprising:
control point logic that when executed in one of the processing systems is operable to communicate with one or more media players and/or with one or more media servers, each media player and media server coupled to the network and conforming to a standard that uses a standard communication control protocol, the control point logic when executed further operable to control any one of media players and any one of the media servers using the standard communication control protocol, the control protocol able to cause playback at a selected media player of a selected item of content of a selected media server, the playback including transfer of the data of the selected item of content from the selected media server to the selected media player; and
control server logic that when executed in one of the processing systems is able to communicate with the control point logic, and is operable to access a control database including information for controlling one or more of the media players and media servers, the control server logic further operable to receive data from one or more remote control devices, the control server module operable to interpret data received from a selected remote control device and to cause the control point module to control any one of media players and/or any one of the media servers according to the received data.

30. Logic as recited in claim 29, wherein the control server logic is further operable when executed to send data to the selected remote control device and further able to interpret data from the control point module and send corresponding data to the selected remote control device.

31. Logic as recited in claim 29, wherein the standard is the Universal Plug and Play standard also denoted UPnP.

32. Logic as recited in claim 29, wherein the control server logic when executed is operable to:
cause a screen of a remote control device to display a user interface that includes a set of locations where there are playback devices and one or more controls operable by a user of the remote control device to select one or more of the locations for playback;
receive from the remote control device a user selection of one or more locations for playback;
cause the remote control device to provide for the user a mechanism to select from a set of content items for playback at the selected one or more locations; and
receive from the remote control device a user selection of one or more of the set of content items and an instruction to playback the selected one or more content items,
such that as a result of user's selecting to playback the one or more content items using the remote control device, playback of the selected one or more content items occurs at the selected more locations.

33. Logic as recited in claim 32, wherein the user interface that includes a set of locations where there are playback devices includes an indication of the last selected location, such a last location is the default location for playback if the user does not change the selected location.

34. Logic as recited in claim 33, wherein the location of the remote control device is automatically determined, such that the default location for playback, if the user does not change the selected location, is the automatically determined location of the remote control device.

35. Logic as recited in claim 32, further comprising;
accessing a database of mappings of which playback devices are available at each location.

36. Logic as recited in claim 32, wherein the mechanism to select from a set of content items enables only selecting content items that are playable at the one or more selected locations.

37. Logic as recited in claim 32, wherein the providing for the user a mechanism to select from a set of content items for playback at a particular location displays a browse location screen that includes content playable at the particular selected location.

38. Logic as recited in claim 32, wherein the providing for the user a mechanism to select from a set of content items for playback at a particular selected location includes a mechanism for the user to search for content items playable at the particular selected location.

39. Logic as recited in claim 32, wherein the providing for the user a mechanism to select from a set of content items for playback at a particular selected location includes a mechanism for the user to enter text.

40. Logic as recited in claim 32, further operable when executed to, as a result of receiving from the remote control a user selection of a particular content item, cause the remote control to provide for the user a set of controls for controlling payback of the particular content item.

41. Logic as recited in claim 40, wherein the providing for the user a set of controls for controlling payback of the particular content item includes providing for the user a subset including content-specific controls, such that the remote control device is able to combine a set of common user interface items with the user interface elements for the content-specific controls to form a user interface for playback of the particular content item, and wherein the user interface for playback of the particular content item depends on one or both of the type of content item and/or the type of playback device for the content item.

42. Logic as recited in claim 40, wherein the providing for the user a set of controls for controlling payback of the particular content item includes causing the remote control device to display graphic elements for control of playback that includes common controls stored in the remote control device and content-specific controls, wherein graphic elements for the content specific controls are stored outside the remote control device.

43. Logic as recited in claim 32, further operable when executed to:
cause the remote control to display on the screen of the remote control a room display interface in which is indicated in which locations a selected media content item is being played.

44. Logic as recited in claim 32, wherein the remote control device includes a mechanism for a user to enter a user identity, such that the content playable by the user is according to a hierarchical privilege system.

45. Logic as recited in claim 44, wherein the hierarchical privilege system is a parental control with a two level hierarchy.

46. Logic as recited in claim 44, wherein the hierarchical privilege system is operable to accord privacy to a user against any other user at the same or lower level in the hierarchy.

47. Logic as recited in claim 32, further operable, when executed to:
ascertain whether or not a particular selected item of content is directly playable at a particular selected location;
in the case it is ascertained that the data is not directly playable, to further ascertain whether transcoding the data of the particular selected item of content would generate transcoded data that would be playable at the particular selected location; and
in the case it is ascertained that the generated transcoded data would be playable, to cause transcoding of the data of the selected media content item to a form playable at the particular selected location.
